(19) United States
(12) Patent Application Publication
(10) Pub. No.: US 2014/0360298 A1
(43) Pub. Date: Dec. 11, 2014

(54) Gear Structure of Servo

(71) Applicant: An-Shih Wei, Kaohsiung City (TW)

(72) Inventor: An-Shih Wei, Kaohsiung City (TW)

(21) Appl. No.: 14/291,067

(22) Filed: May 30, 2014

(30) Foreign Application Priority Data
Jun. 7, 2013 (TW) 102210741

(51) Int. Cl. H02K 7/116

(52) U.S. Cl. CPC H02K 7/116
USPC 74/421 A

(57) ABSTRACT

A gear structure of servo has a control body, a casing and a reduction gear set. The control body has a driving motor. The casing is mounted and covered on the control body and has a receiving space formed between the casing and the control body. The reduction gear set is mounted in the receiving space and has a first gear unit, a second gear unit, a third gear unit and a fourth gear unit. Each one of the gear units engages a corresponding gear unit. Helical gears are used in the reduction gear set, so the abrasion and noises caused by the engagements between the gear units can be reduced via the helical gears, and promote the transmitting efficiency of the driving motor.

### BACKGROUND OF THE INVENTION

1. Field of the Invention

The invention relates to a servo for a remote control mechanism, and more particularly relates to a gear structure of servo that can improve the rotating efficiency of a driving motor of the serve, can be used with low wear, low noise and low power consumption.

2. Description of the Prior Arts

A conventional servo is applied to a remote control mechanism of a model aircraft or a model car to be a driving source. The conventional servo has a main body, a reduction gear set and a swing arm. The main body has a driving integrated circuit (IC) and a driving motor. The driving integrated circuit is mounted in the main body. The driving motor is mounted in the main body and is electrically connected to the driving integrated circuit. The reduction gear set is mounted on a top of the main body, is connected to the driving motor and has multiple gear units. The swing arm is connected to the reduction gear set. The driving motor is driven by the driving integrated circuit, and the swing arm is rotated by the driving motor via the reduction gear set, and this can enable the conventional servo to drive the remote control mechanism of the model aircraft or the model car.

However, each one of the gear units of the reduction gear set is a spur gear, and this enable the gear unit to completely engage another gear unit of the reduction gear set during a rotating process. The teeth of the gear units of the reduction gear set may be worn in a long time use, and this may increase the loading of the driving motor to affect the rotating efficiency of the driving motor. At the same time, the electric power is consumed quickly by the driving motor and the operating durability of the remote control mechanism is decreased.

To overcome the shortcomings, the present invention provides a gear structure of servo to mitigate or obviate the aforementioned problems.

### SUMMARY OF THE INVENTION

The main objective of the present invention is to provide a gear structure of servo that can improve the rotating efficiency of a driving motor of the serve, can be used with low wear, low noise and low power consumption.

The gear structure of servo comprises a control body, a casing and a reduction gear set. The control body has a shell and a driving motor. The driving motor is mounted in the shell and has a driving gear wheel rotatably mounted on the driving motor and extends out of a top of the shell. The casing is mounted on the control body and has a receiving space. The receiving space is formed in the casing. The reduction gear set is mounted on the shell of the control body and is located in the receiving space of the casing.

The reduction gear set has four gear units, respectively a first gear unit, a second gear unit, a third gear unit and a fourth unit. The first gear unit has a passive gear wheel engaging the driving gear wheel and an active gear wheel formed on the passive gear wheel, wherein the active gear wheel is a helical gear. The second gear unit has a passive gear wheel engaging the active gear wheel of the first gear unit and an active gear wheel that is a helical gear. The third gear unit is mounted above the first gear unit and has a passive gear wheel and an active gear wheel, and both of the passive gear wheel and the active gear wheel of the third gear unit are helical gears. The fourth gear unit is mounted on the shell of the control body and engages the third gear unit and has a passive gear wheel engaging the active gear wheel of the third gear unit, and the passive gear wheel of the fourth gear unit is a helical gear.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a gear structure of servo in accordance with the present invention;

FIG. 2 is a partial exploded perspective view of the gear structure of servo in FIG. 1;

FIG. 3 is an exploded perspective view of a reduction gear set and a casing of the gear structure of servo in FIG. 1;

FIG. 4 is a cross-sectional side view in partial section of the casing in FIG. 1; and

FIG. 5 is an enlarged cross-sectional side view of the gear structure of servo in FIG. 4.

### DETAILED DESCRIPTION OF THE PREFERRED EMBODIMENTS

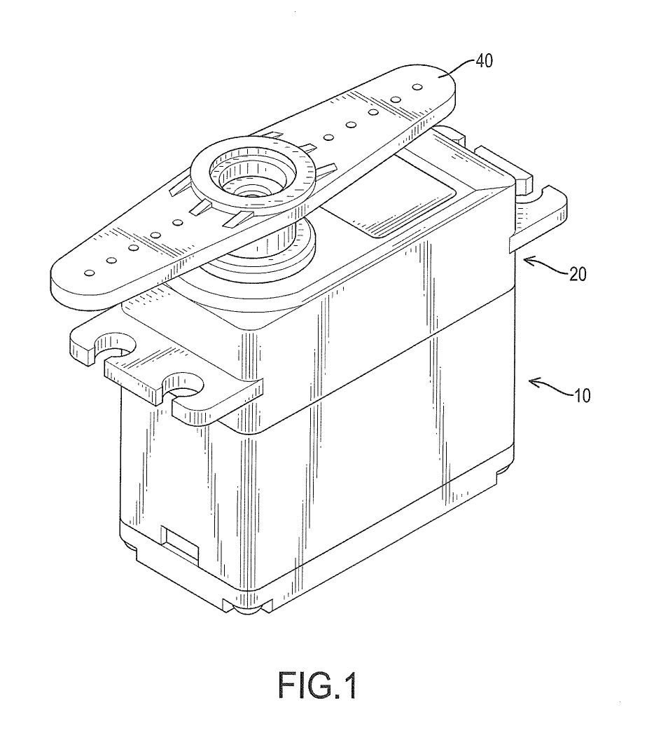

With reference to FIGS. 1 to 3, a gear structure of servo in accordance with the present invention comprises a control body 10, a casing 20 and a reduction gear set 30.

The control body 10 has a shell 11 and a driving motor 12. The shell 11 is a hollow and rectangular shell and has a gear base 111, two limit portions 112, a positioning portion 113, a notch 114, a rotation shaft 115 and a gear locating portion 116. The gear base 111 is a cylindrical step base and is mounted on a top of the shell 11. The limit portions 112 are elongated and are mounted on and protrude from the top of the shell 11 below the gear base 111.

The positioning portion 113 is mounted on the top of the shell 11 and aligns with the gear base 111. The positioning portion 113 has a side face and an interior. The side face of the positioning portion 113 faces the gear base 111. The notch 114 is formed through the side face of the positioning portion 113 and communicates with the interior of the positioning portion 113. The rotation shaft 115 is mounted in and extends through a top of the positioning portion 113.

The gear locating portion 116 is round, is formed on and protrudes from the top of the shell 11 between the gear base 111 and the positioning portion 113. The gear locating portion 116 has a center and a locating hole 1161 formed through the center of the gear locating portion 116.

The driving motor 12 is mounted in the shell 11 below the positioning portion 113 and has a top and a driving gear wheel 121. The driving gear wheel 121 is a spur gear, is rotatably mounted on the top of the driving motor 12, and extends out of the top of the shell 11. In addition, the driving gear wheel 121 extends in the interior of the positioning portion 113 and has a periphery partially extending out of the notch 114.

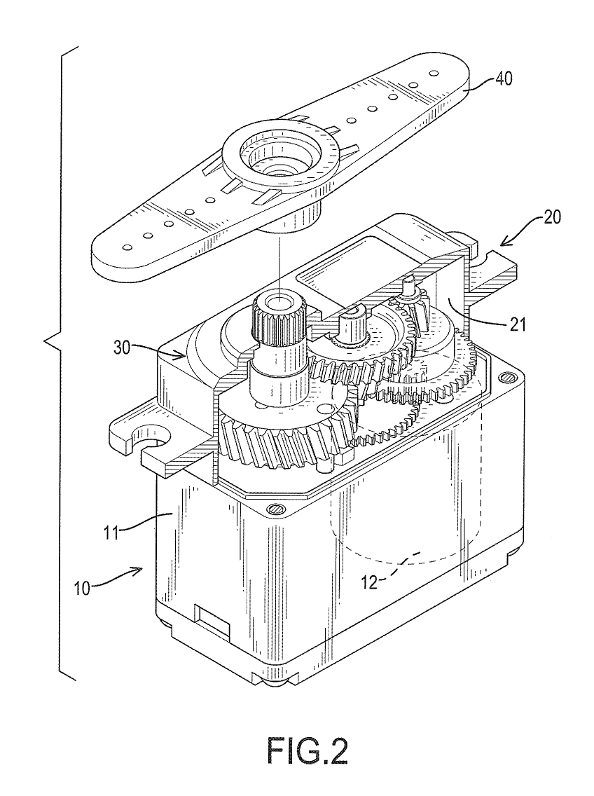

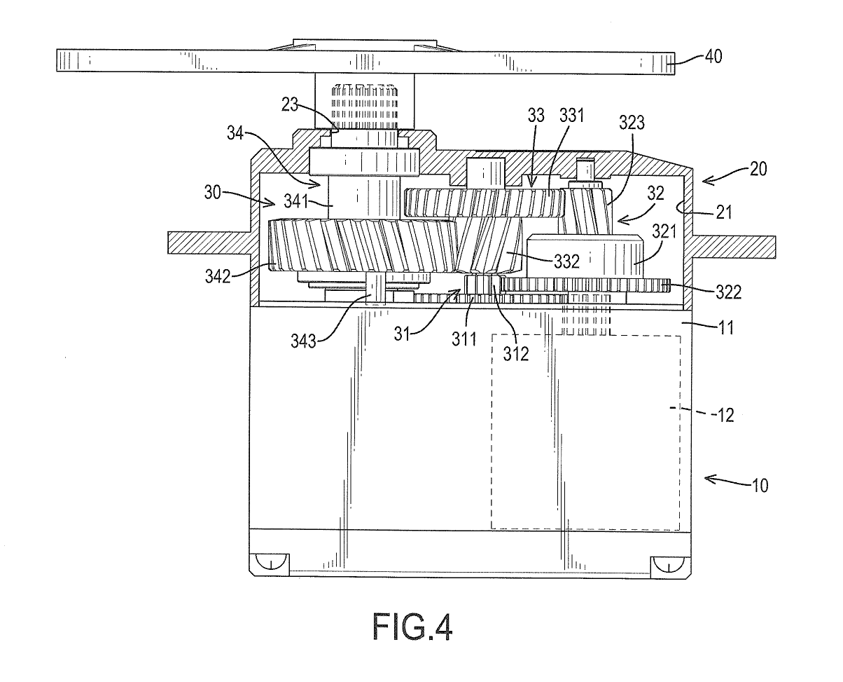

With reference to FIGS. 2 and 4, the casing 20 is mounted on the control body 10 and has an inner top side, a receiving space 21, a stationary shaft 22 and a through hole 23. The receiving space 21 is formed in the casing 20. The stationary shaft 22 is mounted on the inner top side of the casing 20 and is mounted in the locating hole 1161 of the locating portion 116. The through hole 23 is formed through the inner top side of the casing 20 corresponding to the gear base 111.

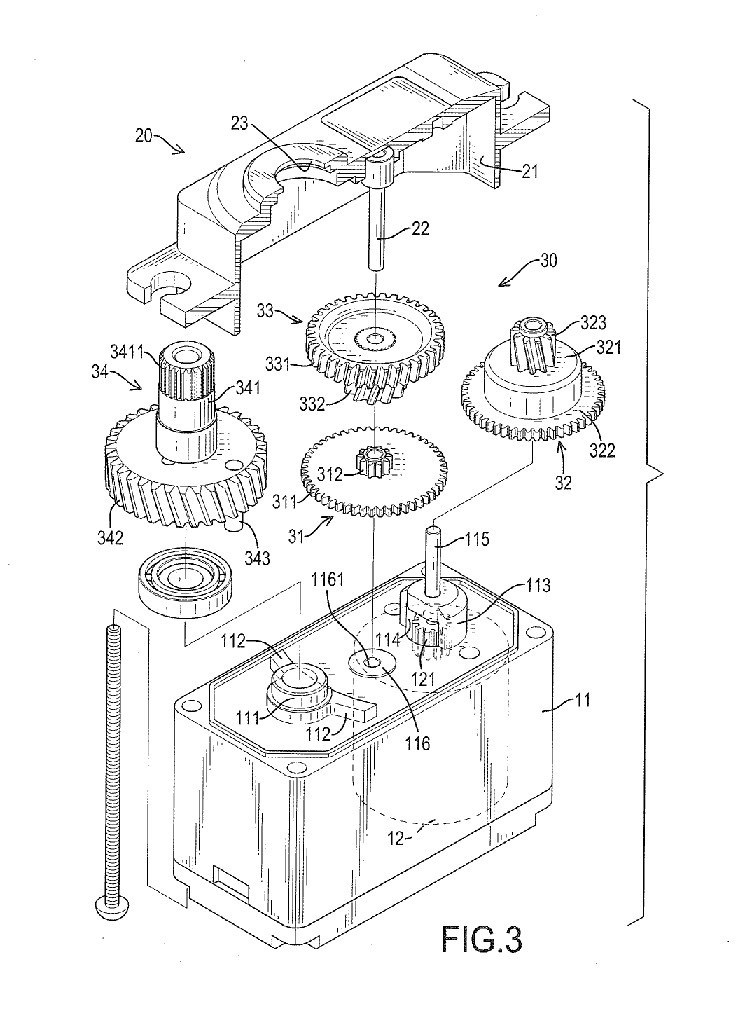

With reference to FIGS. 3 and 4, the reduction gear set 30 is mounted on the shell 11 of the control body 10 and is located in the receiving space 21 of the casing 20. The reduction gear set 30 has four gear units, respectively a first gear unit 31, a second gear unit 32, a third gear unit 33 and a fourth unit 34.

The first gear unit 31 is mounted around the stationary shaft 22, abuts the gear locating portion 116, and engages the driving gear wheel 121 of the driving motor 12. The first gear unit 31 has a passive gear wheel 311 and an active gear wheel 312. The passive gear wheel 311 is rotatably mounted on the gear locating portion 116 and engages the driving gear wheel 121 via the notch 114. The active gear wheel 312 is securely mounted on a top of the passive gear wheel 311 and is mounted around the stationary shaft 22. Both of the passive gear wheel 311 and the active gear wheel 312 are spur gears.

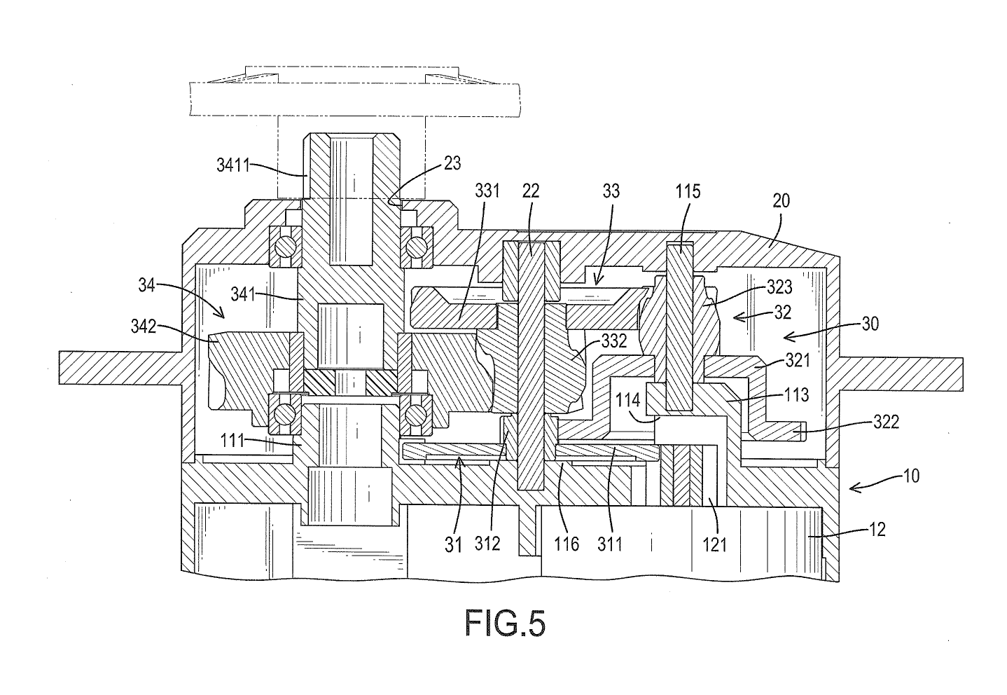

With reference to FIGS. 3 and 5, the second gear unit 32 is rotatably mounted around the rotation shaft 115, is mounted around the positioning portion 113 and has a sleeve portion 321, a passive gear wheel 322 and an active gear wheel 323. The sleeve portion 321 is a cap, is mounted around the positioning portion 113 and has a bottom side. The passive gear wheel 322 is a spur gear, is formed around the bottom side of the sleeve portion 321, and engages the active gear wheel 312 of the first gear unit 31. The active gear wheel 323 is a helical gear, is mounted on a top of the sleeve portion 321 and is mounted around the rotation shaft 115.

The third gear unit 33 is rotatably mounted around the stationary shaft 22 above the first gear unit 31 and has an active gear wheel 332 and a passive gear wheel 331. The active gear wheel 332 is mounted around the stationary shaft 22, abuts the active gear wheel 312 of the first gear unit 31, and has a top. The passive gear wheel 331 is securely mounted on the top of the active gear wheel 332, is mounted around the stationary shaft 22, and engages the active gear wheel 323 of the second gear unit 32. In addition, both of the passive gear wheel 331 and the active gear wheel 332 are helical gears.

With reference to FIGS. 3 and 5, the fourth gear unit 34 is rotatably mounted around the gear base 111, selectively abuts the limit portions 112 and has a passive gear wheel 342, a shaft portion 341 and a lower rod 343. The passive gear wheel 342 is a helical gear, is mounted around the gear base 111, and engages the active gear wheel 332 of the third gear unit 33. The shaft portion 341 is formed on and protrudes from a top of the passive gear wheel 342, extends out of the casing 20, and has a top end, an external surface and a gear surface 3411. The top end of the shaft portion 341 extends out of the casing 20 via the through hole 23. The gear surface 3411 is formed around the external surface of the shaft portion 341 near the top end of the shaft portion 341. The lower rod 343 is mounted on and extends downwardly out of a bottom face of the passive gear wheel 342 between the limit portions 112 and selectively abuts one of the limit portions 112 to limit a rotating angle of the fourth gear unit 34.

Furthermore, the pitch diameter of the passive gear wheel 311, 322, 331 of each one of the gear units 31, 32, 33 of the reduction gear set 30 is respectively longer than the pitch diameter of the corresponding active gear wheel 312, 323, 332 of each one of the gear units 31, 32, 33 of the reduction gear set 30. In addition, a pitch diameter of the passive gear wheel 342 is longer than a pitch diameter of the gear surface 3411 of the shaft portion 341.

With reference to FIGS. 1 and 4, a swing arm 40 is connected to the top end of the shaft portion 341 of the fourth gear unit 34. The driving motor 12 of the control body 10 is driven by electric power, and the driving gear wheel 121 is rotated by the driving motor 12. Then, the swing arm 40 is rotated with the shaft portion 341 relative to the casing 20 and the control body 10 sequentially by the engagements between the driving gear wheel 121 and the passive gear wheel 311 of the first gear unit 31, the active gear wheel 312 of the first gear unit 31 and the passive gear wheel 322 of the second gear unit 32, the active gear wheel 323 of the second gear unit 32 and the passive gear wheel 331 of the third gear unit 33, and the active gear wheel 332 of the third gear wheel 33 and the passive gear wheel 342 of the fourth gear unit 34.

The active gear wheel 323 of the second gear unit 32, the passive gear wheel 331 of the third gear unit 33, the active gear wheel 332 of the third gear unit 33 and the passive gear 341 are helical gears, and the helical gears come into engagement with each other gradually. Then, the abrasion and noises that are caused by the rotation of the reduction gear set 30 can be reduced to improve the rotating efficiency of the driving motor 12 and this can reduce the power consumption of the driving motor 12 and can enhance the operating durability of the servo.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A gear structure of servo comprising:
a control body having
a shell; and
a driving motor mounted in the shell and having
a driving gear wheel mounted on a top of the driving motor and extending out of a top of the shell;
a casing mounted on a top of the control body and having a receiving space formed in the casing; and
a reduction gear set mounted on the top of the shell, mounted in the receiving space of the casing, and having
a first gear unit rotatably mounted in the casing, engaging the driving gear wheel of the driving motor, and having
a passive gear wheel rotatably mounted on the top of the shell and engaging the driving gear wheel; and
an active gear wheel formed on a top of the passive gear wheel;
a second gear unit rotatably mounted on the shell of the control body, engaging the first gear unit, and having
a passive gear wheel rotatably mounted on the shell and engaging the active gear wheel of the first gear unit; and
an active gear wheel being a helical gear and securely mounted on the passive gear wheel of the second gear unit;
a third gear unit rotatably mounted on the shell of the control body above the first gear unit, engaging the second gear unit, and having
an active gear wheel being a helical gear and abutting the active gear wheel of the first gear unit; and
a passive gear wheel being a helical gear, mounted on a top of the active gear wheel of the third gear unit, and engaging the active gear wheel of the second gear unit; and
a fourth gear unit rotatably mounted on the shell of the control body, engaging the third gear unit, and having
a passive gear wheel being a helical gear and engaging the active gear wheel of the third gear unit.

2. The gear structure of servo as claimed in claim 1, wherein
the shell has
a gear base mounted on the top of the shell;
a positioning portion mounted on the shell, aligning with the gear base, and having an interior and a side face facing the gear base;
a notch formed through the side face of the positioning portion and communicating with the interior of the positioning portion; and
a rotation shaft mounted in and extending through a top of the positioning portion;
the fourth gear unit is rotatably mounted around the gear base;
the second gear unit is rotatably mounted around the rotation shaft; and
the driving gear wheel extends in the interior of the positioning portion and has a periphery partially extending out of the notch.

3. The gear structure of servo as claimed in claim 2, wherein
the control body has two limit portions being elongated, mounted on and protruding from the top of the shell below the gear base; and
the fourth gear unit has a lower rod mounted on and extending out of a bottom face of the passive gear wheel of the fourth gear unit between the limit portions and selectively abutting one of the limit portions.

4. The gear structure of servo as claimed in claim 2, wherein
the shell has a gear locating portion formed on and protruding from the top of the shell between the gear base and the positioning portion and having a center and a locating hole formed through the center of the gear locating portion;
the casing has a stationary shaft mounted on an inner top side of the casing and mounted in the locating hole of the locating portion; and
the first gear unit is rotatably mounted on the gear locating portion and is mounted around the stationary shaft; and
the third gear unit is mounted around the stationary shaft above the first gear unit.

5. The gear structure of servo as claimed in claim 3, wherein
the shell has a gear locating portion formed on and protruding from the top of the shell between the gear base and the positioning portion and having a center and a locating hole formed through the center of the gear locating portion;
the casing has a stationary shaft mounted on an inner top side of the casing and mounted in the locating hole of the locating portion; and
the first gear unit is rotatably mounted on the gear locating portion and is mounted around the stationary shaft; and
the third gear unit is mounted around the stationary shaft above the first gear unit.

6. The gear structure of servo as claimed in claim 4, wherein
a pitch diameter of the passive gear wheel of each one of the first gear unit, the second gear unit and the third gear unit of the reduction gear set is respectively longer than a pitch diameter of the corresponding active gear wheel of each one of the first gear unit, the second gear unit and the third gear unit of the reduction gear set;
the fourth gear unit has a shaft portion formed on and protruding from a top of the passive gear wheel of the fourth gear unit, the shaft portion extending out of the casing and having a top end, an external surface and a gear surface formed around the external surface of the shaft portion near the top end of the shaft portion; and
a pitch diameter of the passive gear wheel of the fourth gear unit is longer than a pitch diameter of the gear surface of the shaft portion of the fourth gear unit.

7. The gear structure of servo as claimed in claim 5, wherein
a pitch diameter of the passive gear wheel of each one of the first gear unit, the second gear unit and the third gear unit of the reduction gear set is respectively longer than a pitch diameter of the corresponding active gear wheel of each one of the first gear unit, the second gear unit and the third gear unit of the reduction gear set;
the fourth gear unit has a shaft portion formed on and protruding from a top of the passive gear wheel of the fourth gear unit, the shaft portion extending out of the casing and having a top end, an external surface and a gear surface formed around the external surface of the shaft portion near the top end of the shaft portion; and
a pitch diameter of the passive gear wheel of the fourth gear unit is longer than a pitch diameter of the gear surface of the shaft portion of the fourth gear unit.
